(19) United States
(12) Patent Application Publication
(10) Pub. No.: US 2015/0369599 A1
(43) Pub. Date: Dec. 24, 2015

(54) METHOD FOR LOCATING A DEVICE WHICH IS MOVED IN A THREE-DIMENSIONAL SPACE

(71) Applicants: Commissariat à l'énergie atomique et aux énergies alternatives, Paris (FR); MOVEA, Grenoble (FR)

(72) Inventor: Christophe Villien, Seyssinet-Pariset (FR)

(21) Appl. No.: 14/741,896

(22) Filed: Jun. 17, 2015

(30) Foreign Application Priority Data
Jun. 18, 2014 (FR) 1455576

(51) Int. Cl. G01B 21/16

(52) U.S. Cl. CPC G01B 21/16

(57) ABSTRACT

A method of location of a device includes the provision of a map containing at least one zone with favored direction of displacement associated with a favored direction of displacement. The method includes an operation of detecting the presence of a particle inside the zone. If the particle is detected as being present inside the zone, an operation of increasing a weight of the particle if the angular deviation between the direction of displacement of the particle from a position Pₖ₋₁ⁱ to a position Pₖⁱ and the favored direction of displacement associated with this zone is equal to 0° or to 180° to within plus or minus σ_{γ}. If the particle is detected as being outside of this zone, the method includes prohibiting the use of this favored direction of displacement to update the weight of the particle.

### RELATED APPLICATIONS

Under 35 USC 119, this application claims the benefit of the Jun. 18, 2014 priority date of French Application FR 1455576, the content of which is herein incorporated by reference in its entirety.

### FIELD OF INVENTION

The invention relates to a method of location of a device which is displaced inside a three-dimensional space. The subject of the invention is also an information recording medium, an electronic unit and a device for the implementation of this method.

### BACKGROUND

Such methods are particularly useful when a method of location of the device by GPS (“Global Positioning System”) is not possible. This is for example often the case inside buildings.

Known methods of location use the measurements of an inertial platform housed inside the device itself to measure its direction of displacement and the amplitude of its displacement in this direction from a previous position. Among these known methods, some use particle filters to estimate the position of the device in the three-dimensional environment. Accordingly, particle filters exploit the fact that there exist predefined constraints on the displacements of the device inside the three-dimensional environment. For example, a typical constraint is that a displacement cannot pass through a wall.

Thus, these known methods of location typically comprise:

a) the provision of a map of the three-dimensional space and of predefined constraints on the displacements of the device in this three-dimensional space,

b) the generation, by an electronic computer, of several distinct particles, each particle being associated:
with coordinates coding its position on the map, and
with a weight representing the probability that the device is situated at the site of this particle,

c) the reception of measurements representative of the direction of displacement of the device and of the amplitude of this displacement from its previous position, these measurements being carried out by sensors onboard the displaced device,

d) the updating of the coordinates of the position of each particle as a function of the measurements received during step c) and of a predetermined displacement law for displacing this particle from its previous position Pₖ₋₁ⁱ to a new position Pₖⁱ in a manner correlated with the measured displacement of the device, each displacement law comprising for this purpose at least one first measured variable whose value is dependent on the measurement of the direction of displacement received during step c) and a second measured variable whose value is dependent on the measurement of the amplitude of this displacement received during step c), and then

e) for each particle, if the latest displacement of this particle from the position Pₖ₋₁ⁱ to the position Pₖⁱ satisfies the predefined constraints, the increasing of the weight associated with this particle with respect to the weights of the particles whose latest displacement infringes these predefined constraints,
the repetition of steps c) to e), and

f) the estimation of the position of the device on the basis of the positions of the particles and of the weights associated with these particles by allotting, during this estimation, more importance to the positions of the particles associated with the highest weights.

Such known methods of location of a device implementing a particle filter are for example disclosed in:
patent applications WO 2012158441 and U.S. Pat. No. 8,548,738B1,
in the article O. Woodman et al., “Pedestrian localization for indoor environments”, ACM, 2008.

Such a method is also disclosed in detail in the thesis of J. Straub, “Pedestrian indoor localization and tracking using a particle filter combined with a learning accessibility map”, thesis, August 2010, Technical University of Munich. This thesis is downloadable at the following address: http://people.csail.mit.edu/jstraub/download/Straub10PedestrianLocalization.pdf.

Subsequently, this thesis is referenced through the term “Straub 2010”.

Prior art is also known from:
Sanjeev Arulampalam M. Et Al, “A tutorial on particle filters for Online Non linear/Non Gaussian Bayesian Tracking”, IEEE Transaction on signal processing, New York, vol. 50, No 2, Feb. 1, 2002,
WO2012/009328A1,
US2014/149069A1.

### SUMMARY OF INVENTION

The invention is aimed at proposing a method of location of the device that is more precise.

Its subject is therefore a method of this type, as claimed in claim 1.

The method hereinabove makes it possible to exploit moreover the fact that there may exist zones of a map in which the directions of displacement are not equiprobable. This makes it possible to more rapidly and more precisely adjust the weight of the particles situated in the zone with favored direction of displacement and therefore to increase the precision of the estimation of the position of the device.

The embodiments of this method of location can comprise one or more of the additional characteristics of the dependent claims.

These embodiments of the method of location furthermore exhibit the following advantages:
the use of a corrective factor makes it possible to obtain a more precise location of the device even in the presence of a bias, for example, in the direction of displacement or in the amplitude of the displacement of this device;
applying the corrective factor to the measured variable corresponding to the amplitude of the displacement of the device makes it possible to automatically correct a bias in the amplitude of the displacement of this device;
applying the corrective factor to a measured variable corresponding to the direction of the displacement of the device makes it possible to automatically correct a bias in the direction of displacement;
during the step of generating new particles, associating these new particles with initial values for the corrective factor which are close to the corrective factor's current values associated with the particles which have not been eliminated makes it possible to increase the precision of the estimation of the value of the corrective factor and therefore of the position of the device as the iterations of steps c) to e) proceed;
using, in the guise of predefined constraints, the existence of obstacles which are impassable to the device in the three-dimensional environment makes it possible to accelerate the convergence of the method of location toward a precise estimation of the position of the device;
dividing the map into several zones and associating with each of these zones a list of identifiers of the impassable obstacles contained inside this zone makes it possible to retain a simple tiling of the map into several zones while being capable of using impassable obstacles situated entirely inside these zones;
dividing the map into several zones and associating with each of these zones a displacement law which makes it possible to estimate with more precision the displacement of the device in this zone than if another displacement law associated with another zone were used makes it possible to increase the precision of the estimation of the position of the device.

The subject of the invention is also an information recording medium comprising instructions for the execution of the above method of location, when these instructions are executed by an electronic computer.

The subject of the invention is also an electronic unit for locating a device displaceable inside a three-dimensional space.

Finally, the subject of the invention is also a device directly transportable by a pedestrian who is moving in displacement inside a three-dimensional space, this device comprising:
an inertial platform able to measure physical quantities representative of the direction of displacement of this device and of the amplitude of this displacement, and
the electronic locating unit hereinabove.

The invention will be better understood on reading the description which follows, given solely by way of nonlimiting example and while referring to the drawings.

### BRIEF DESCRIPTION OF THE DRAWINGS

FIG. 1 is a vertical sectional schematic illustration of a building inside which is implemented a method of location of a device;

FIG. 2 is a schematic illustration of a location device;

FIG. 3 is a schematic illustration of a map used to locate the device of FIG. 2 in the building of FIG. 1;

FIG. 4 is a flowchart of a method of location implemented by the device of FIG. 2.

### DETAILED DESCRIPTION

In these figures, the same references are used to designate the same elements. Hereinafter in this description, the characteristics and functions that are well known to the person skilled in the art are not described in detail.

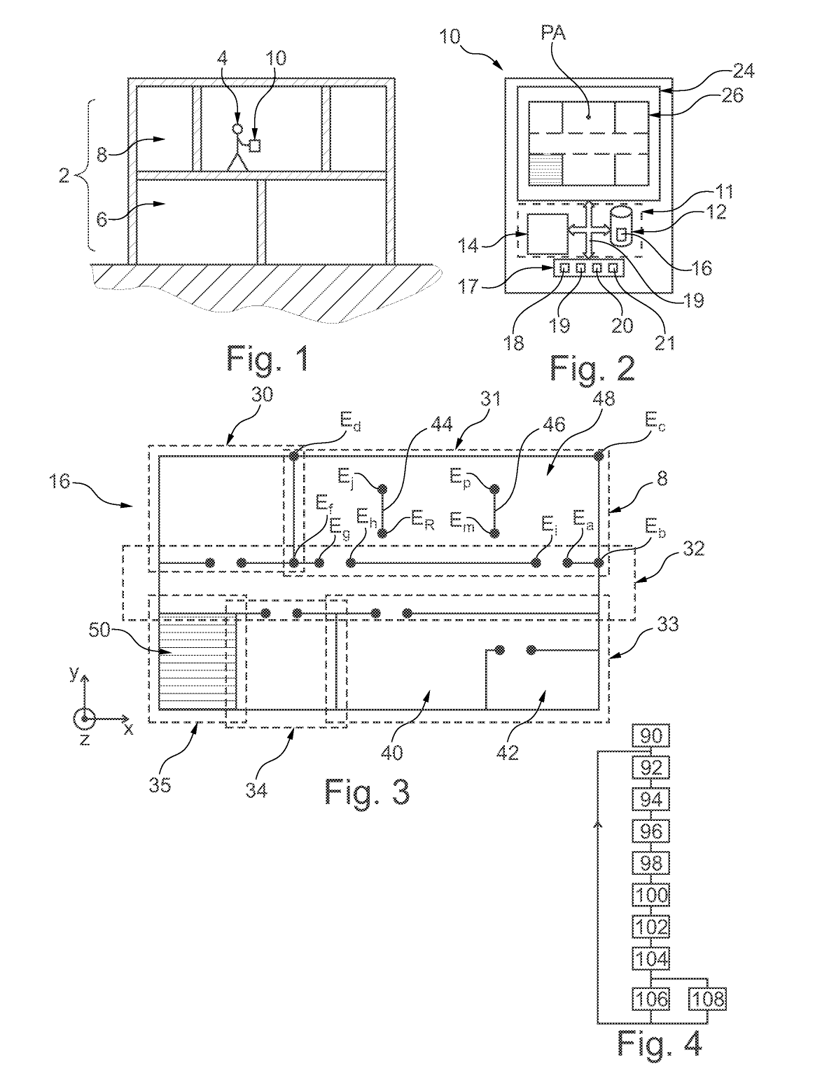

FIG. 1 represents an assembly comprising a building 2, inside which a pedestrian 4 can move freely by walking. The building 2 is divided into several stories. Here, only a ground floor story 6 and a first story 8 are represented. The stories are linked together by zones of change of story such as a staircase or an elevator. Each story comprises rooms and corridors delimited by impassable walls which the pedestrian 4 cannot cross. The pedestrian 4 can enter a room only by passing through a door. Here, the interior of a room can also comprise obstacles which are impassable to the pedestrian 4 such as, for example, pillars or other construction elements of the building 2.

To aid the pedestrian 4 to locate themself inside the building 2, the latter transports a location device 10 directly in their hand. The device 10 is capable of locating itself on a map of the building 2 without recourse to sensors other than those which it comprises internally. In particular, the device 10 can chart its position inside the building 2 without using a navigation system calling upon external charting beacons implanted in the environment of the building 2. These external beacons can be satellites or radio wave emitters fixed to the building 2. In particular, the device 10 can chart its position without using a GPS system (“Global Positioning System”).

FIG. 2 represents the device 10 in greater detail. The device 10 comprises an electronic locating unit 11. This unit 11 comprises a memory 12 as well as a programmable electronic computer 14 capable of executing instructions recorded in the memory 12. For this purpose, the memory 12 comprises the instructions necessary for executing the method of FIG. 4. Moreover, the memory 12 comprises a map 16 of the building 2. This map is described in greater detail with reference to FIG. 3.

The device 12 also comprises an inertial platform 17. The inertial platform 17 transmits to the computer 14, by way of an information transmission bus 19, measurements of the direction in which the device 10 is moving and of the amplitude of the displacement in this direction from the latest logged position of this device 10. For this purpose, for example, the inertial platform 17 comprises a three-axis accelerometer 18, a gyrometer 19 and a three-axis magnetometer 20. Here, the inertial platform 17 also comprises a barometer 21 for measuring the altitude of the device 10.

The device 10 is equipped with a screen 24 making it possible to display a graphical representation 26 of the map 16 and, on this graphical representation, a point PA representing the current position of the device 4 inside the building 2. This point PA is therefore situated in the graphical representation 26 at the site of the map 16 corresponding to the current position of the device 10 and therefore of the pedestrian 4.

For example, the device 10 is a smartphone or an electronic tablet programmed to execute the method of FIG. 4.

FIG. 3 graphically represents the content of the map 16 for the story 8 of the building 2. What will now be described in respect of the story 8 of the building 2 applies to each story of this building and to the ground floor story 6.

The map 16 comprises several zones 30 to 35 whose juxtaposition covers the entire area of the story 8. These zones are parallel to the floor of the story and contained in one and the same plane called the “plane of the story”. This plane of the story is typically horizontal.

The zones 30 to 35 are contiguous and do not overlap. However, to increase the readability of FIG. 3, the zones 30 to 35 are represented as overlapping but, in reality, this is not the case. Thus, here, each portion of the periphery of each zone is common with at most one portion of the periphery of another different zone.

Conventionally, the edges of each zone are situated at the site of an obstacle which is impassable to the pedestrian 4 such as a wall. However, here, one and the same zone can encompass several rooms of the building 2. This is for example the case for the zone 33 which surrounds a room 40 and another smaller room 42. In FIG. 3, the periphery of each room is delimited by walls represented by thin lines. Moreover, each room comprises at least one opening for accessing the interior of this room. In FIG. 3, the openings are situated between the wall ends marked by points. An opening is typically a door.

A zone can also encompass obstacles situated in the interior of a room which are impassable to the pedestrian 4. For example, an impassable obstacle is an interior partition or a pillar or any other element of the building 2 which the pedestrian 4 cannot cross. Such a zone is illustrated by the zone 31 which comprises two partitions 44 and 46 situated inside a room 48.

Here, each zone is a polygon. Hence, for each zone, the map 16 contains:
an identifier of this zone, and
the coordinates, in an XYZ frame, of the vertices of the polygon delimiting this zone.

The XYZ frame is an orthogonal frame in which the X and Y directions are horizontal and the Z direction is vertical. In this embodiment, each zone is rectangular. Thus, only the coordinates of the two diagonally opposite vertices of a zone are recorded in the map 16 so as to economize on memory.

For each zone, the map 16 also comprises:
a list of identifiers of just the impassable obstacles situated inside this zone or on the periphery of this zone,
an identifier of a law of displacement inside this zone, and
optionally, a favored direction of displacement.

The position and the dimensions of each impassable object are here coded by a horizontal segment contained in the plane of the floor. Thus, each obstacle identifier is associated with a pair of points E_{jd} and E_{jf}. The points E_{jd} and E_{jf} mark, respectively, the start and the end of the segment [E_{jd}; E_{jf}], where j is the identifier of the impassable obstacle. The coordinates of the points E_{jd} and E_{jf}, in the plane of the floor, are known and contained in the map 16. Hence, for example, the zone 31 comprises eight obstacle identifiers IdO₁ to IdO₈. The identifiers IdO₁ to IdO₈ correspond, respectively, to the segments [Eₐ; E_{b}]; [E_{b}; E_{c}]; [E_{c}; E_{d}]; [E_{d}; E_{f}]; [E_{f}; E_{g}]; [Eₕ; Eᵢ]; [Eⱼ; E_{R}] and [Eₚ; Eₘ]. The position of the points Eₐ to Eₘ is represented in FIG. 3.

Each displacement law makes it possible to compute, on the basis of the measurements of the inertial platform 17, at an instant tₖ, the displacement of a particle Sⁱ from a previous position Pₖ₋₁ⁱ up to a new position Pₖⁱ. This displacement is directly correlated with that of the device 10. Typically, this displacement between the positions Pₖ₋₁ⁱ and Pₖⁱ is identical or very close to that of the device 10 between the instants tₖ₋₁ and tₖ. Subsequently, the superscript “i” is the identifier of the particle and the subscript “k” is the order number of the instant at which the direction and the amplitude of the displacement of the device 10 are measured.

The inertial platform 17 measures the angle θₖ, in the plane of the story, between the direction of displacement of the device 10 and the X direction. For this purpose, it is possible to use the measurements of the gyrometer 19 and of the magnetometer 20. Subsequently, the direction measured at the instant tₖ is called “direction θₖ”.

The inertial platform 17 is also capable of providing a physical quantity representative of the amplitude Iₖ of the displacement of the device 10 in the direction θₖ between the instants tₖ₋₁ and tₖ. For this purpose, it is possible to integrate the measurement of the accelerometer 18 between the instants tₖ₋₁ and tₖ and, if the measurement is zero, retain the previous measured speed vₖ₋₁. However, in the case of a pedestrian who is walking on a horizontal floor, to obtain a more precise estimation of the amplitude Iₖ, the computer 14 detects on the basis of the measurements of the accelerometer 18 the instant at which a foot of the pedestrian 4 comes into contact with the floor. On the basis of these successive instants, the computer 14 computes a frequency fₖ of the footsteps of the pedestrian 4. Next, the amplitude Iₖ of the displacement of the pedestrian 4 in the direction θₖ is computed by using the following footstep model: Oₖ=Afₖ+BT+C, where A, B, C and T are constant coefficients independent of the measurements of the inertial platform 17. Moreover, the coefficients A, B and C are coefficients which are independent of the morphological characteristics of the pedestrian. On the other hand, the coefficient T must be chosen equal to the height of the pedestrian 4. By default, the coefficient T is taken equal to the mean height of a human being, for example 1.78 m. The speed vₖ of displacement of the device 10 between the instants tₖ₋₁ and tₖ is obtained with the aid of the following relation: vₖ=Iₖ/Δt, where Δt is the duration of the time interval between tₖ₋₁ and tₖ. Typically, Δt is chosen equal to the duration of a footstep of the pedestrian 4.

Thus, when the pedestrian 4 moves by walking on the floor of the story 8, a displacement law is given by the following relations:

xₖⁱ=xₖ₋₁ⁱ+vₖ×Δt×cos θₖ;

yₖⁱ=yₖ₋₁ⁱ+vₖ×Δt×sin θₖ,

where (xₖⁱ, yₖⁱ) and (xₖ₋₁ⁱ, yₖ₋₁ⁱ) are the coordinates, in the plane of the floor, of the positions Pₖⁱ and Pₖ₋₁ⁱ of the particle Sⁱ.

In the case of a method of location of the device 10 implementing a particle filter, it is beneficial to explore the largest possible number of trajectories with the particles. Thus, conventionally, the displacement of each particle is disturbed in a random manner. For example, accordingly, the usable displacement law is the following:

xₖⁱ=xₖ₋₁ⁱ+vₖ×Δt×cos θₖ+μₓⁱ;

yₖⁱ=yₖ₋₁ⁱ+vₖ×Δy×sin θₖ+μ_{y}ⁱ;

where μₓⁱ and μ_{y}ⁱ are random variables.

At each instant tₖ and for each particle Sⁱ, the values of these variables μₓⁱ and μ_{y}ⁱ are randomly drawn as a function of a predefined centered probability law, that is to say characterized by a zero mathematical expectation. Thus, the mean of the values of each random variable μₓⁱ and μ_{y}ⁱ at the various successive instants tₖ tends to zero as k increases. For example, this predefined probability law is the same for the random variables μₓⁱ and μ_{y}ⁱ and for all the particles Sⁱ. Subsequently, it is denoted Lp_{xy}. This law Lp_{xy} is characterized by a predetermined standard deviation σ_{xy}. Here, the standard deviation σ_{xy} is constant and independent of the measurements of the inertial platform 17 for an updating at each footstep. For example, the standard deviation σ_{xy} is greater than 5 cm or 10 cm and, preferably, less than 35 cm. For example, the law Lp_{xy} is a uniform distribution or a Gaussian distribution.

In reality, there may also exist a measurement bias, called the direction bias, in the measurement of the direction θₖ. Such a direction bias may originate from a defect in the sensors of the inertial platform 17. This direction bias may also be caused by the fact that the pedestrian 4 rotates the device 10 in a horizontal plane. In a similar manner, there may also exist a measurement bias, called here the footstep bias, in the measurement of the amplitude Iₖ of the displacement of the device 10. This footstep bias may originate from a defect of the sensors of the inertial platform. In the example described here, it may also originate from a modeling error and more precisely from an error with respect to the default value of the coefficient T in the footstep model. Indeed, the actual height of the pedestrian 4 is unknown. Thus, if the pedestrian 4 is much shorter or much taller than 1.78 m, this introduces a systematic footstep bias in the measurement of the amplitude Iₖ. Typically, these biases are constant at least over a time interval that is long enough to be able to estimate them and correct them as described subsequently.

Here, to compensate and correct these direction and footstep biases, the displacement law used integrates corrective factors, respectively αⁱ and εⁱ, associated with each particle Sⁱ. For example, the displacement law is given by the following relations:

xₖⁱ=xₖ₋₁ⁱ+vₖ×Δt×(1+εₖⁱ)×cos(θₖ+αₖⁱ)+μₓⁱ;

yₖⁱ=yₖ₋₁ⁱ+vₖ×Δt×(1+εₖⁱ)×sin(θₖ+αₖⁱ)+μ_{y}ⁱ;

εₖⁱ=εₖ₋₁ⁱ+μ_{ε}ⁱ;

αₖⁱ=αₖ₋₁ⁱ+μ_{α}ⁱ;

where:
εₖⁱ and εₖ₋₁ⁱ are the values, respectively at the instants tₖ and tₖ₋₁, of the corrective factor εⁱ used to correct the footstep bias, and
αₖⁱ and αₖ₋₁ⁱ are the values, respectively at the instants tₖ and tₖ₋₁, of the corrective factor αⁱ used to correct the direction bias,
μ_{ε}ⁱ and μ_{α}ⁱ are random variables.

The random variables μ_{ε}ⁱ and μ_{α}ⁱ are used for the same reasons and in the same manner as the variables μₓⁱ and μ_{y}ⁱ introduced previously. Thus, a new value of the variables μ_{ε}ⁱ and μ_{α}ⁱ is randomly drawn at each new instant tₖ and for each particle Sⁱ as a function, respectively, of a predefined probability law Lp_{ε} and of a predefined probability law Lp_{α}. Typically, these laws Lp_{ε} and Lp_{α} are the same for all the particles Sⁱ. Here, the mathematical expectations of the laws Lp_{ε} and Lp_{α} are equal to zero. Consequently, just as for the random variables μₓⁱ and μ_{y}ⁱ, the mean of the values of each random variable μ_{ε}ⁱ, and μ_{α}ⁱ at the various successive instants tₖ tends to zero as k increases.

Moreover, the function of the variables μ_{ε}ⁱ, and μ_{α}ⁱ is only to slightly disturb the previous values εₖ₋₁ⁱ and αₖ₋₁ⁱ of the corrective factors εⁱ and αⁱ so that the values of the corrective factors εⁱ and αⁱ remain stable over time. For this purpose, the standard deviations σ_{ε}and σ_{α}, respectively, of the laws Lp_{ε} and Lp_{α} do not allow a fast variation of the values of the corrective factors εⁱ and αⁱ. Here, for this purpose, the standard deviation σ_{ε} is chosen sufficiently small for the ratio Σσ_{εk}/T to be less than 10%/s and, preferably, less than 5%/s or 1%/s, where:
σ_{εk} is the standard deviation of the law Lp_{ε} during the k-th iteration of step 96,
Σσ_{εk} is the sum of the standard deviations σ_{εk} between the q-th iteration and the p-th iteration of step 96, where q is an integer strictly less than p,
T is the duration in seconds of the time interval which has elapsed between the q-th and the p-th iteration of step 96.

Step 96 is the step during which the coordinates of the particle Sⁱ are updated. This step is described in greater detail with reference to FIG. 4. Here, the standard deviation σ_{ε} is constant. Thus, the previous ratio can also be written: (p−q)σ_{ε}/T. In this case, whatever p and q, the ratio is constant. The difference p−q is generally large enough to cover a time period of greater than 1 s or 4 s and, generally, less than 10 min or 5 min or 1 min. For example, this difference between p and q is constant whatever p.

In a similar manner, the standard deviation σ_{α} is chosen sufficiently small for the ratio Σσ_{αk}/T to be less than 10°/s and, preferably, less than 5°/s or 1°/s, where:
σ_{αk} is the standard deviation of the law Lp_{α} during the k-th iteration of step 96,
Σσ_{αk} is the sum of the standard deviations σ_{αk} between the q-th iteration and the p-th iteration of step 96, where q is an integer strictly less than p,
T is the duration in seconds of the time interval which has elapsed between the q-th and the p-th iteration of step 96.

Here, the standard deviation σ_{α} is also constant. Thus, the previous ratio can also be written: (p−q)σ_{α}/T.

Just as for the variables μₓⁱ and μ_{y}ⁱ, the variables μ_{ε}ⁱ, and μ_{α}ⁱ make it possible to explore a large number of possible values for the corrective factors εⁱ and αⁱ.

The displacement law described hereinabove is subsequently called the first displacement law. This first displacement law operates in most situations where the pedestrian 4 walks on a horizontal ground. On the other hand, in certain particular cases, there exist other more precise displacement laws. For example, the zone 35 is a stairwell comprising a staircase 50. In this zone 35, the length of the footsteps of the pedestrian 4 is imposed by the depth Lₘ of the stairs of this staircase 50. Thus, in the zone 35, it is preferable to use a second displacement law. Here, this second displacement law is identical to the first displacement law except that the product vₖⁱ×Δt×(1+εₖⁱ) is replaced with the measured variable nₖⁱ. The variable nₖⁱ is given by the following relation: nₖⁱ=(Ent(|zₖⁱ−zₖ₋₁ⁱ|/Hₘ))×Lₘ, where:
zₖ₋₁ⁱ and zₖⁱ are the heights of the device 10 measured by the inertial platform 17 at the instants tₖ₋₁ and tₖ, respectively,
Hₘ is the constant height of a stair of the staircase 50,
Lₘ is the depth of a stair of the staircase 50,
   |zₖⁱ−zₖ₋₁ⁱ| is the function which returns the absolute value of the difference between zₖⁱ and zₖ₋₁ⁱ, and
Ent ( . . . ) is the function which returns the integer part of |zₖⁱ−zₖ₋₁ⁱ|/Hₘ.

Here, it is assumed that the height Hₘ and the depth Lₘ are known in advance and recorded in the map 16.

The values of the measured variables zₖ and zₖ₋₁ are obtained, typically, on the basis of the measurements of the barometer 21. Here, only the zone 35 is associated with this second displacement law. All the other zones of the story 8 are associated with the first displacement law.

Inside the building 2, there exist zones such as the zones 30, 31, 33 and 34 in which the pedestrian 4 can move freely in all directions. Stated otherwise, in these zones, it is considered that all the directions of displacement are equiprobable. In this case, these zones are devoid of favored direction of displacement. Conversely, there exist zones of the building 2 where not all the directions of displacement are equiprobable. For example, the zone 32 is a long corridor parallel to the X direction. In this zone 32, the most probable directions of displacement for a pedestrian are parallel to the X direction. Indeed, it is less probable for the pedestrian 4 to move transversely to the longitudinal direction of the corridor. In this case, there is said to be a favored direction of displacement in this zone 32. Here, each favored direction is coded by an angle γ, in the plane of the floor, between this favored direction and the X direction. Moreover, in this embodiment, an angular tolerance σ_{γ} is also associated with each favored direction. This angular tolerance is generally expressed in degrees or in radians. For example, in the case of the zone 32, the angle γ=0° and the angular tolerance σ_{γ}=±30°. In the embodiment described here, the zone 35 is also associated with a favored direction for ascending and descending the staircase 50. For this favored direction, the angle γ=90° and the angular tolerance σ_{γ} is equal to ±20°.

The manner of operation of the device 10 will now be described with reference to the method of FIG. 4.

To locate the position of the device 10 inside the building 2, the unit 11 implements a location algorithm known by the term “particle filter”. The manner of operation of a particle filter is well known. For example, the reader can refer to the prior art cited in the introduction of this patent application and, in particular, to Straub 2010. Thus, subsequently, only the new specifics of implementation of this algorithm are described in detail. In particular, the management of the changes of stories is carried out, for example, as described in Straub 2010.

The method starts with a step 90 when location of the device 10 is triggered. For example, location is triggered manually by the pedestrian 4 by interacting with the man-machine interface of the device 10. The computer 14 then generates an initial assembly of N₀ particles Sⁱ, where i is an identifier of the particle making it possible to distinguish it from among the set of other particles generated. The number N₀ of particles Sⁱ depends in particular on the initial knowledge that one has about the position of the device 10 in the building 2 and the area of this building. Typically, N₀ is greater than 10 or 100. N₀ is also generally less than 5000 or 1000. Each particle Sⁱ is initially associated:
with an initial position P₀ⁱ inside the building 2, this position P₀ⁱ comprising the coordinates x₀ⁱ, y₀ⁱ and z₀ⁱ of the particle Sⁱ in the XYZ frame,
with an initial value w₀ⁱ of the weight wⁱ representing the probability that the device 10 is situated at the site of this particle Sⁱ at the instant t₀,
with an initial value α₀ⁱ for the corrective factor αⁱ, and
with an initial value ε₀ⁱ for the corrective factor εⁱ.

During step 90, the initial position P₀ⁱ and the initial values w₀ⁱ, α₀ⁱ and ε₀ⁱ are initialized. Numerous schemes for initializing the positions P₀ⁱ and the values w₀ⁱ of each particle are known. For example, if the initial position of the device 10 is known to within plus or minus 1 m, the values P₀ⁱ of all the particles Sⁱ are drawn at random inside a circle centered on the known position and of radius equal to 1 m. It is also possible to take each value w₀ⁱ equal to 1/N₀, where N₀ is the initial number of particles generated.

Each value α₀ⁱ is drawn at random in such a way that the distribution of the initial values α₀ⁱ follows a predetermined probability law Lp_{α0} such as a uniform or Gaussian or other distribution. The law Lp_{α0} is generally not the same as the law Lp_{α} which is used to obtain the values of the random variable μ_{α}ⁱ. It is the a priori knowledge that one has about the distribution of the direction bias which makes it possible to choose the probability law for the initial values α₀ⁱ which most resembles the one observed in reality. For example, it is also this a priori knowledge about the distribution of the direction biases which makes it possible to fix the value of the standard deviation σ_{α0} of the law Lp_{α0}. For example, the standard deviation σ_{α0} is chosen equal to 360° if one has no information about the direction bias. In another example, the standard deviation σ_{α0} is chosen less than 45° if one has a little information about the direction bias. In contradistinction to the case of the previous random variables, this probability law Lp_{α0} does not necessarily have a zero mean.

Each initial value ε₀ⁱ is chosen as described previously for the initial values α₀ⁱ except that a predefined probability law Lp_{α0} is used for the footstep bias, instead of the law Lp_{α0}. Moreover, the probability law Lp_{ε0} is not necessarily identical to the law Lp_{α0}. Indeed, generally, the direction bias and footstep bias are not correlated. Typically, the standard deviation σ_{ε0} of the law Lp_{ε0} is equal 30% to within plus or minus 5% if one has no information about the footstep bias. In another example, the standard deviation σ_{ε0} is chosen less than 20% if one has a little information about the footstep bias.

Thereafter, during a step 92, the inertial platform 17 transmits its measurements to the computer 14 which receives them. On the basis of these measurements, the computer 14 computes the speed vₖ and the angle θₖ of the current displacement of the device 10 from its latest position. Here, new measurements of the speed vₖ and of the angle θₖ are computed each time that the computer detects that a foot of the pedestrian has just touched the floor.

During a step 94, the computer 14 identifies, for each particle Sⁱ, the zone inside which it is currently situated. Accordingly, for each particle Sⁱ, the computer compares the latest known position Pₖ₋₁ⁱ of this particle with the periphery of each zone of the map 16. For example, in the case of rectangular zones aligned with the XYZ frame, the computer 14 tests whether the following two inequalities are satisfied:

x_{Aj}≦xₖ₋₁ⁱ and y_{Aj}≦yₖ₋₁ⁱ≦y_{Bj},

where:
the subscript j is an identifier of the zone of the map 16 making it possible to distinguish it from the other zones,
x_{Aj} and y_{Aj} are the coordinates of that vertex of zone j which is closest to the origin of the XYZ frame, and
x_{Bj} and y_{Bj} are the coordinates of that vertex of zone j which is furthest from the origin of the XYZ frame.

If these two inequalities are satisfied, then the particle Sⁱ belongs to zone j. Preferably, the computer 14 tests firstly whether the particle Sⁱ belongs to the same zone as that to which it belonged previously. If a particle Sⁱ does not belong to any zone, then a particular processing is triggered. For example, this particle is eliminated.

During a step 96, once the zone to which each particle Sⁱ belongs has been identified, each particle is displaced in a manner correlated with the measured displacement of the device 10 from its previous position Pₖ₋₁ⁱ up to a new position Pₖⁱ. Accordingly, the coordinates of each particle Sⁱ are updated as a function:
of the latest measurements received from the inertial platform 17,
of the coordinates of the previous position Pₖ₋₁ⁱ of this particle, and
of the displacement law associated with the zone inside which the particle Sⁱ is situated.

The displacement law to be used is therefore that associated with the zone identified during step 94.

For example, if the particle Sⁱ is situated inside one of the zones 30 to 34, then the coordinates of the new position Pₖⁱ are established using the first displacement law. On the other hand, if the particle Sⁱ is situated inside the zone 35, then the coordinates of the new position Pₖⁱ are established using the second displacement law.

At each new execution of step 96, the new values for the variables μₓⁱ, μ_{y}ⁱ, μ_{α}ⁱ and μ_{ε}ⁱ, are randomly drawn with the aid of the laws Lp_{xy}, Lp_{α}, and Lp_{ε}, respectively.

During a step 98, the computer 14 updates the weights wⁱ of each particle Sⁱ. More precisely, the computer 14 decreases the weight wⁱ of the particle Sⁱ if its latest displacement from the position Pₖ₋₁ⁱ to the position Pₖⁱ has infringed predefined constraints associated with the zone inside which it is situated.

Typically, for each particle Sⁱ, the computer here verifies the following constraints:
constraint 1): the segment [Pₖ₋₁ⁱ; Pₖⁱ] must not cross an impassable obstacle of the zone inside which this particle Sⁱ is situated;
constraint 2): the direction of the displacement from the position Pₖ₋₁ⁱ to the position Pₖⁱ complies with the favored direction of displacement associated with the zone inside which the particle Sⁱ is situated.

Generally, here a constraint on the displacement of the particle Sⁱ is defined as being a condition which, if it is satisfied by the particle Sⁱ, is used to increase the weight wⁱ of this particle Sⁱ with respect to the weight of the particles which do not satisfy this condition. Conversely, if this condition is not satisfied by the particle Sᵢ, then it is used to decrease the weight wⁱ of this particle Sⁱ with respect to the weights of the particles which satisfy this condition.

To evaluate the constraint 1), for each particle Sⁱ, the computer 14 searches for whether there exists an intersection between the segment [Pₖ₋₁ⁱ; Pₖⁱ] and each impassable obstacle of the zone inside which the particle is situated. This zone was identified during step 94. This intersection search is carried out solely with the impassable obstacles whose identifiers are contained in the list associated with the identified zone. Here, since each obstacle is coded by a segment, this intersection search amounts to searching for an intersection between two segments.

If an intersection exists, then a very low or zero value is assigned to the weight wⁱ. A very low value is a value less than 0.2 or 0.1 for example. In the converse case, the value of the weight wⁱ remains unchanged.

If the zone inside which the particle Sⁱ is situated is not associated with a favored direction, then the constraint 2) is not used to update the weight wⁱ. In the converse case, the constraint 2) is used. To evaluate the constraint 2), the computer 14 computes a weight w_{θ}ⁱ on the basis of the deviation between the direction measured θₖ for the displacement of the particle Sⁱ and the favored direction of the zone inside which it is situated. The value of the weight w_{ω}ⁱ is all the larger the lower the angular deviation between the favored direction γ and the direction of displacement from the position Pₖ₋₁ⁱ to Pₖⁱ. Moreover, here, the value of the weight w_{θ}ⁱ is established while taking account of the tolerance σ_{γ} associated with this favored direction. The value of the weight w_{θ}ⁱ is therefore larger if the angular deviation between the direction of displacement of the particle Sⁱ and the favored direction lies in the tolerance margin defined by the value of σ_{γ} and, in the converse case, the value of the weight wⁱ, is smaller.

For example, here, the value of the weight wⁱ, is computed with the following relation: w_{σ}ⁱ=p×exp[(θₖ+αₖⁱ−γ)²/(2σ_{γ}²)], where p is a predefined constant coefficient. It will be noted that the value αₖⁱ of the corrective factor αⁱ of the direction bias is also used to compute this weight w_{σ}ⁱ.

Thereafter, the value of the weight wⁱ is taken equal to its previous value multiplied by the value of the weight w_{θ}ⁱ thus obtained.

During a step 100, the computer 14 undertakes the normalization of the weights wⁱ of all the particles Sⁱ so that the sum of all these weights is equal to one. For example, the computer 14 computes the sum W of all the weights wⁱ and then divides each weight wⁱ by the sum W.

During a step 102, the computer 14 re-samples the particles Sⁱ. This re-sampling step consists in eliminating the particles whose weights wⁱ have become too low to replace them with particles associated with parameters whose weights are higher.

Numerous re-sampling techniques are known. For example, here, we apply the SIR (Sequential Importance Resampling) scheme described in the following book: B. Ristic, S. Arulampalam, N. Gordon, “Beyond the Kalman Filter, particle filter for tracking applications”, Artech House, 2004.

To summarize, this re-sampling scheme firstly consists in classing the particles into two groups: the particles to be regenerated, that is to say all the particles whose weight is below a predetermined threshold and the surviving particles, that is to say the other particles.

Thereafter, for each particle to be regenerated, the computer 14 eliminates the old particle and then generates a new particle to replace it. To generate a new particle, the computer 14 randomly draws a particle from the group of surviving particles. This chance drawing is carried out preferably in such a way that the probability of being drawn is proportional to the weight of the surviving particle.

Thereafter, the position Pₖⁱ and the values αₖⁱ and εₖⁱ of the drawn surviving particle are assigned to the new generated particle. During this step, preferably, the computer adds a random disturbance on the position and on the values of the corrective factors by using, for example, the random variables μₓ, μ_{y}, μ_{α} and μ_{ε}. However, these disturbances are calibrated in such a way that the values αₖⁱ and εₖⁱ assigned to the generated particle remain very close to the current values for the corrective factors associated with the surviving particle drawn. Typically, the mean of the values αₖⁱ which are assigned to the generated particles is closer to the mean of the values αₖⁱ of the surviving particles than to the mean of the values αₖⁱ of the eliminated particles. The same holds for the values εₖⁱ assigned to the generated particles.

A new weight is also assigned to each generated particle and, optionally, to the surviving particle from which it arises.

During a step 104, the computer 14 estimates the position PA of the device 10 on the basis of the positions Pₖⁱ and of the weights wⁱ of all the particles Sⁱ. Numerous schemes are possible for doing this. For example, the position PA is taken equal to that of the particle Sⁱ having the highest weight wⁱ. In another embodiment, the position PA is taken equal to the mean of the positions Pₖⁱ of the particles Sⁱ on weighting each position Pₖⁱ by the weight wⁱ. Another scheme is also described in application WO 2012158441.

Finally, during a step 106, a point is displayed at the position PA on the graphical representation 26 of the map 16 to indicate to the pedestrian 4 his position on this map and therefore his position inside the building 2.

Steps 92 to 106 are repeated in a loop. As these iterations proceed, the precision of the estimation of the position of the device 10 increases since only the most probable positions Pₖⁱ are retained.

In parallel with step 104, during a step 108, the computer 14 computes an estimation E_{α} of the direction bias and an estimation E_{ε} of the footstep bias on the basis, respectively, of the current values αₖⁱ and εₖⁱ of the particles Sⁱ. For example, the estimation E_{α} is taken equal to the mean of the current values αₖⁱ of all the particles Sⁱ. In a similar manner, the value of the estimation E_{ε} is taken equal to the mean of the current values εₖⁱ of all the particles Sⁱ.

The precision of the estimations E_{α} and E_{ε} increases as the repetitions of steps 92 to 106 proceed. Indeed, it is very probable that the particle Sⁱ associated with an incorrect current value for the corrective factor αⁱ or εⁱ will rapidly infringe the constraints evaluated during step 98. Hence, the particles Sⁱ associated with incorrect current values for the corrective factors are preferably eliminated during step 102. Thus, as the iterations of steps 92 to 106 proceed, the particles Sⁱ associated with correct current values for the corrective factors are preferably selected as surviving particles during step 102. Hence, the estimations E_{α} and E_{ε} converge toward the actual values of the direction bias and the footstep bias.

Moreover, since the values of the corrective factors αⁱ and εⁱ converge toward the actual values of the direction and footstep biases as the iterations of steps 92 to 106 proceed, the corrective factors correct these direction and footstep biases more and more precisely. Hence, the presence of these corrective factors in the displacement law makes it possible to substantially increase the precision of the estimation of the position PA even in the presence of such direction and footstep biases.

The estimations E_{ε} and E_{α} can be displayed on the screen 24 or used by other applications to correct the direction and footstep biases.

Numerous other embodiments are possible. For example, certain more sophisticated sensors provide a mean value of the variable measured at an instant k as well as a standard deviation in this measurement (see for example Straub 2010). In this case, the measured values of the angle θₖ and of the amplitude Iₖ are obtained by drawing the values at random using a Gaussian probability law whose mean and standard deviation are equal to those transmitted by the sensors. This makes it possible in particular to take the measurement noise into account.

What was described previously in the particular case where it is a pedestrian who directly carries the device 10 may also be adapted to other situations. For example, the device 10 can be fixed on a trolley pushed by the pedestrian. In this case, the speed vₖ is obtained by integrating the acceleration measured by the trolley. Another solution consists in detecting the frequency of the impacts which occur each time a wheel of the trolley rolls over a join between two flagstones of a ground pavement. The method of location described also applies to the case where the device 10 is transported by a motorized robot which moves without the aid of the pedestrian 4. In this case, the amplitude of the displacement can be measured by measuring the number of wheel revolutions of a driving wheel of the robot.

The method described above applies to any type of three-dimensional space where the device 10 can be displaced. For example, it may also entail a space situated outdoors and outside any building. For example, this method is useful to locate a person in a place where location by GPS or on the basis of telephonic relay is impossible.

Other ways of coding the constraints on the displacement of the device 10 exist and are usable in the above method. For example, rather than recording the position of the walls, it is possible to record all the possible paths. If the displacement of a particle does not follow one of these possible paths, then its weight is decreased. Such an embodiment is described in greater detail in application WO 2012158441 and in application U.S. Pat. No. 8,548,738. Rather than recording the position of the walls, it is also possible to record the position of the doors. In the latter case, the weight of a particle is increased if the latter goes from one room to another by passing through a door. Such an embodiment is described in greater detail in Straub 2010.

Other predefined constraints can be used to update the value of the weight wⁱ. For example, if an approximate measurement of the position of the device 10 is available by using other information, then the weight wⁱ is increased if the position Pₖⁱ is close to this approximate position and, on the contrary, decreased if the position Pₖⁱ is far from this approximate position. For example, the approximate position is obtained on the basis of the power of a radioelectric signal received by the device 10 and of the known position in the XYZ frame of the emitter of this radioelectric signal. For example, the emitter is a Wi-Fi terminal.

Although the constraint consisting in testing the collision of a particle with an impassable obstacle is, in practice, the one used most often, it is not absolutely necessary if there exist other predefined constraints such as those described above which can be used.

As a variant, step 100 of normalizing the weight wⁱ of the particles Sⁱ is omitted.

During the re-sampling of the particles, numerous other algorithms for determining the initial position of the regenerated particles are known and may be used instead of that described above. For example, the KLD (Kullbak-Leibler-Divergence) algorithm can be used.

Likewise, other algorithms are possible for associating a new current value αₖⁱ and εₖⁱ with each regenerated particle. Each new value αₖⁱ is dependent on one or more of the values αₖⁱ associated with the particles which have not been eliminated and is independent of the values αₖⁱ associated with the particles which have been eliminated. The same holds for the new value εₖⁱ.

In a simplified variant, the re-sampling step 102 is omitted. Even if the re-sampling is not undertaken, the method hereinabove makes it possible to increase the precision of the location of the position of the device 10 since the weight wⁱ of each particle Sⁱ associated with an incorrect current value αₖⁱ or εₖⁱ decreases as the iterations of steps 92 to 104 proceed.

Other schemes for determining whether a particle is situated inside a zone are possible. For example, Straub 2010 describes an alternative scheme usable in the case of polygonal zones of more complicated shape than a simple rectangle.

Shapes of zones other than polygons are possible. For example, a zone can have the shape of a circle. In this case, the coordinates of its center and of its radius are recorded in the map 16. There is in reality no limitation on the shape of a zone as long as the coordinates of the periphery of this zone can be determined in the XYZ frame.

The above method has been described in the particular case where each zone is associated at one and the same time with impassable-obstacle identifiers, a displacement law and a favored direction. However, it may frequently happen that the displacement law is the same for several immediately contiguous zones. For example, here, this is the case for zones 30 to 34 which are all associated with the first displacement law. In this case, it may be more beneficial to record in the map 16 several stacked strata of zones for one and the same story. Each stratum comprises at least one zone and, typically, a set of several zones covering the entire area of the floor. The zones of one stratum are distinguished from the zones of another stratum by the type of property that it associates with this zone. For example, a first stratum comprises solely zones associated only with impassable-obstacle identifiers. A second stratum comprises solely zones associated only with a respective displacement law. Finally, a third stratum comprises only zones associated solely with a favored direction. When such a stack of strata is applied to the story 8, the zones of the first stratum are, for example, identical to the zones 30 to 35 except that they comprise only the identifiers of impassable obstacles. Here the second stratum is limited to two zones. One of them is identical to the zone 35 except that it is solely associated with the second displacement law. The other zone of this second stratum corresponds to the union of zones 30 to 34 and is solely associated with the first displacement law. Here the third stratum comprises four zones. The first and second zones are identical, respectively, to zones 32 and 35 except that they are solely associated with a respective favored direction. The third zone corresponds to the union of zones 30 and 31 and the fourth zone then corresponds to the union of zones 33 and 34 which are not associated with any favored direction.

The manner of operation of the method of location with a map comprising several strata is identical to that described above except that, for each particle S′, the zone of each stratum inside which it is situated is identified. Thereafter, it is these zones inside which it is situated which make it possible to identify the displacement law to be used and the predefined constraints to be tested so as to update the value of its weight wⁱ. The use of several strata of zones may simplify the definition of these zones.

In another variant, one of these strata corresponds to an accessibility map such as described in Straub 2010 in chapter 5.1.2. However, preferably, the various contiguous boxes of the accessibility map of Straub 2010 that are associated with the same value of the degree Λ of accessibility are grouped together within one and the same zone.

Each zone can also be associated with additional predefined constraints for updating the weight wⁱ of the particles situated in this zone. For example, it is possible to associate with each zone a coefficient wₐ of accessibility which represents the probability that a pedestrian enters this zone. Thereafter, when updating the weight wⁱ of a particle Sⁱ situated in this zone, the weight wⁱ is taken equal to its previous value multiplied by this coefficient wₐ.

Other displacement laws are usable. For example, the standard deviations σ_{α} and σ_{ε} are not necessarily constant. In this case, they are constant over long durations and then modified for a brief time interval before returning to their previous values. For example, solely during this brief time interval, the ratios Σσ_{εk}/T and/or Σσ_{αk}/T are permitted to exceed the previously defined thresholds. Typically, the temporary increasing of the values of the standard deviations σ_{α} and σ_{ε} is used to reinitialize the current values αₖⁱ and εₖⁱ. Generally, the values of the standard deviations σ_{α} and σ_{ε} are constant for more than 90% of the time of use of the device 10 so as to prevent, during this 90% of the time, a fast variation of the values of the corrective factors εⁱ and αⁱ. It is possible to verify that the ratio Σσ_{εk}/T is maintained below a predetermined threshold over at least 90% of the time of use, for example, by taking the difference p-q equal to a constant. Thereafter, the ratio Σσ_{εk}/T is computed for each value of p corresponding to an iteration of step 96 occurring during this time of use. If at least 90% of the ratios thus computed are below the predetermined threshold, then this ratio is maintained below this predetermined threshold for more than 90% of the time of use. The same computation can be used for the ratio Σσ_{αk}/T. The time of use is for example a period of continuous use of the device 10 without stopping the execution of the method of FIG. 4.

In another variant, the expectation of one of the probability laws Lp_{ε} or Lp_{α} is non-zero. This then introduces an additional bias which is added to the real bias. The current value εₖⁱ or αₖⁱ can also be computed on the basis of a previous value other than εₖ₋₁ⁱ or αₖ₋₁ⁱ. For example, εₖⁱ is computed on the basis of the previous value εₖ₋ₙⁱ, where n is a constant strictly greater than one. Thus, it is also possible to use the following relations to compute the current value of εₖⁱ: εₖⁱ=(εₖ₋₁ⁱ+εₖ₋₂ⁱ)/2+μ_{ε}ⁱ or εₖⁱ=εₖ₋₂ⁱ+μ_{ε}ⁱ. The same thing applies to the computation of the current value αₖⁱ.

Moreover, if it is known that the direction bias is zero or negligible, then the first and the second displacement laws are simplified by eliminating the corrective factor αⁱ. Conversely, if it is known that the footstep bias is zero or negligible, then the first displacement law is simplified by eliminating the corrective factor εⁱ. The corrective factor remaining in the first displacement law is thereafter estimated as described above with reference to FIG. 4. Conversely, it is possible to add additional corrective factors to the first displacement law. For example, if the best possible value of the coefficient A in the footstep model of the first displacement law is not known precisely, it is then possible to use the following footstep model Iₖ=πAfₖ+BT+C, where π is an additional corrective factor. The value of the factor π is then estimated in the same manner as was described for the corrective factors αⁱ and εⁱ. It will be noted that in the case of the corrective factor π, the latter is a multiplicative factor and not a subtractive factor, that is to say that it multiplies the measured variable fₖ.

Displacement laws other than those described above may be used. For example, a displacement law specifically adapted to the displacement on an escalator or on a moving walkway or in an elevator can readily be designed and associated with the zone comprising this escalator, this moving walkway or this elevator. Moreover, if there exists a measurement bias in these particular zones, then it is desirable to introduce a corrective factor into the displacement law to compensate this measurement bias. If, initially, the value of this corrective factor is not known, then this value is estimated in the same manner as was described for the corrective factors αⁱ and εⁱ.

Step 106 or 108 is not necessarily carried out after each iteration of steps 92 to 104. For example, these steps are carried out only one time out of two.

The previous embodiments have been described in the particular case where all the processings to determine the position PA are carried out by the computer 14 of the device 10. As a variant, these processings are distributed over several distinct computers. One of these distinct computers can be that of a computer server mechanically independent of the device 10. For example, the device 10 transmits the measurements to this server and this server determines the position PA and then returns the position PA determined to the device 10 which displays it on its screen 24. In this case, the map 16 is also recorded in the memory of this server.

The selection of a specific displacement law as a function of the zone in which the particle is situated can be implemented independently of the other characteristics of the method of FIG. 4. In particular, this selection of the displacement law can be implemented independently of the use of corrective factors such as the factors αⁱ and εⁱ and/or independently of the use, in the guise of predefined constraints, of the favored directions of displacement.

Likewise, the use of favored directions of displacement associated with zones can also be implemented independently of the other characteristics of the method of FIG. 4. In particular, the use, in the guise of predefined constraints, of the favored directions of displacement can be implemented independently of the use of corrective factors such as the factors αⁱ and εⁱ and/or independently of the selection of the displacement law as a function of the zone inside which the particle is situated.

1. A method of location of a device which is displaced inside a three-dimensional space, the method comprising:
a) the provision of a map of the three-dimensional space and of predefined constraints on the displacements of the device in the three-dimensional space,
b) the generation, by an electronic computer, of several distinct particles, each particle being associated:
with coordinates coding its position on the map, and
with a weight representing the probability that the device is situated at the site of this particle,
c) the reception of measurements representative of the direction of displacement of the device and of the amplitude of this displacement from its previous position, these measurements being carried out by sensors onboard the displaced device,
d) the updating of the coordinates of the position of each particle as a function of the measurements received during step c) and of a predetermined displacement law for displacing this particle from its previous position Pₖ₋₁ⁱ to a new position Pₖⁱ in a manner correlated with the measured displacement of the device, and then
e) for each particle, if the latest displacement of this particle from the position Pₖ₋₁ⁱ to the position Pₖⁱ satisfies the predefined constraints, the increasing of the weight associated with this particle with respect to the weights of the particles whose latest displacement infringes these predefined constraints,
the repetition of steps c) to e), and
f) the estimation of the position of the device on the basis of the positions of the particles and of the weights associated with the particles by allotting, during the estimation, more importance to the positions of the particles associated with the highest weights,
wherein:
during step a), the map provided contains at least one zone with favored direction of displacement associated:
with coordinates defining the position on the map of its periphery, and
with a favored direction of displacement in this zone,
step e) comprises for each particle:
an operation of detecting the presence of th particle inside the zone with favored direction of displacement by comparing the coordinates of this particle with the periphery of the zone with favored direction of displacement defined by the coordinates provided during step a), and then,
if the particle is detected as being present inside the zone with favored direction of displacement, an operation of increasing the weight of this particle if the angular deviation between the direction of displacement of this particle from the position Pₖ₋₁ⁱ to the position Pₖⁱ and the favored direction of displacement associated with the zone is equal to 0° or to 180° to within plus or minus σ_{γ}, the increasing being carried out with respect to the weights of the other particles situated inside the same zone and for which the deviation is not equal to 0° or to 180° to within plus or minus σ_{γ}, where σ_{γ} is a predetermined angular tolerance, and
if the particle is detected as being outside of the zone with favored direction of displacement, the prohibiting of the use of the favored direction of displacement associated with this zone to update the weight of the particle.

2. The method as claimed in claim 1, in which
the displacement law comprises:
at least one first measured variable whose value is dependent on the measurement of the direction of displacement received during step c), and
a second measured variable whose value is dependent on the measurement of the amplitude of this displacement received during step c), and
a corrective factor of a bias combined by an arithmetical operation with one of the measured variables, and
each particle is also associated with a current value of this corrective factor, the current value of the corrective factor being constructed at each iteration of step d) on the basis of a previous current value of the corrective factor, computed during a previous iteration of step d), to which is added a random variable drawn according to a predefined probability law, and the current values of various particles being initialized, before the first execution of step d), to various initial values, and
during step d), for each particle whose coordinates are updated with the aid of the displacement law, the value of the corrective factor in the displacement law is taken equal to the corrective factor's current value associated with the particle.

3. The method as claimed in claim 2, in which the corrective factor is, in the displacement law, added together or multiplied with the second measured variable and the variation of the standard deviation a, of the predefined probability law is maintained below 10% per second for more than 90% of the time of use of the method for locating the device, the variation of the standard deviation a, being given by the following ratio: Σσ_{εk}/T, where:
σ_{εk} is the standard deviation of the predefined probability law during the k-th iteration of step d),
τσ_{εk} is the sum of the standard deviations σ_{εk} between the q-th iteration and the p-th iteration of step d), where q is an integer strictly less than p,
T is the duration in seconds of the time interval which has elapsed between the q-th and the p-th iteration of step d).

4. The method as claimed in claim 2, in which the corrective factor is, in the displacement law, added together or multiplied with the first measured variable and the variation of the standard deviation σ_{α} of the predefined probability law is maintained below 10° per second for more than 90% of the time of use of the method for locating the device, the variation of the standard deviation σ_{α} being given by the following ratio: τσ_{αk}/T, where:
σ_{αk} is the standard deviation of the predefined probability law during the k-th iteration of step d),
Σσ_{εk} is the sum of the standard deviations σ_{αk} between the q-th iteration and the p-th iteration of step d), where q is an integer strictly less than p,
T is the duration in seconds of the time interval which has elapsed between the q-th and the p-th iteration of step d).

5. The method as claimed in claim 2, in which, after several iterations of steps c) to e), the method comprises a step of re-sampling the particles during which:
the particles associated with the lowest weights are eliminated, and
new particles are automatically generated to replace the eliminated particles, a new current value of the corrective factor being assigned to each new particle, each new value being dependent on one or more of the corrective factor's current values associated with the particles which have not been eliminated and independent of the corrective factor's current values associated with the particles which have been eliminated.

6. The method as claimed in claim 1, in which:
during step a), the predefined constraints provided contain coordinates coding the positions and the dimensions of obstacles which are impassable to the device in the three-dimensional space, and
step e) comprises, for each particle:
the search for an intersection between the segment [Pₖ₋₁ⁱ; Pₖⁱ] and an impassable obstacle by using the coordinates of the impassable obstacle which are provided during step a), and
the decreasing of the weight associated with the particle if such an intersection exists and, in the converse case, the absence of decreasing or the increasing of the weight associated with the particle.

7. The method as claimed in claim 6, in which:
during step a), the map provided contains several distinct zones, each distinct zone being associated:
with coordinates defining the position on the map of its periphery, and
a list of identifiers of just the impassable obstacles situated inside this zone,
step e) systematically comprises for each particle:
an operation of identifying the zone inside which the particle is situated by comparing the updated coordinates of the particle with the peripheries of the zones of the map which are defined by the coordinates provided during step a), and then
an operation of searching for an intersection between the segment [Pₖ₋₁ⁱ; Pₖⁱ] and solely the impassable obstacles whose identifiers are contained in the list associated with the zone identified during the identification operation.

8. The method as claimed in claim 1, in which:
during step a), the map provided contains several distinct zones, each distinct zone being associated:
with coordinates defining the position on the map of its periphery, and
a displacement law from among a set of several different displacement laws, the displacement law associated with a zone making it possible to estimate more precisely, on the basis of the same measurements received, the direction and the amplitude of the displacement of the device when the latter is situated inside this zone than if any one of the other displacement laws of the set were used, for this purpose the different displacement laws are distinguished from one another by the mathematical operations which link the coordinates of a particle to the measurements received during step c), and
step d) systematically comprises for each particle:
an operation of identifying the zone inside which the particle is situated by comparing the coordinates of the particle with the peripheries of the zones of the map which are defined by the coordinates provided during step a), and then
an operation of use for the updating of the coordinates of the particle of just the displacement law associated with the zone identified during the identification operation.

9. An information recording medium, which comprises instructions for executing a method as claimed in claim 1, when the instructions are executed by an electronic computer.

10. An electronic unit for locating a device displaceable inside a three-dimensional space, the electronic unit comprising:
a memory containing a map of the three-dimensional space and predefined constraints on the displacements of the device in the three-dimensional space,
an electronic computer programmed for:
b) generating several distinct particles, each particle being associated:
with coordinates coding its position on the map, and
with a weight representing the probability that the device is situated at the site of the particle,
c) receiving measurements representative of the direction of displacement of the device and of the amplitude of the displacement from its previous position, the measurements being carried out by sensors onboard the displaced device,
d) updating the coordinates of the position of each particle as a function of the measurements received and of a predetermined displacement law for displacing the particle from its previous position Pₖ₋₁ⁱ to a new position Pₖⁱ in a manner correlated with the measured displacement of the device,
e) for each particle, if the latest displacement of the particle from the position Pₖ₋₁ⁱ to the position Pₖⁱ satisfies the predefined constraints, increasing the weight associated with the particle with respect to the weights of the particles whose latest displacement infringes these predefined constraints,
repeating steps c) to e), and
f) estimating the position of the device on the basis of the positions of the particles and of the weights associated with the particles by allotting, during the estimation, more importance to the positions of the particles associated with the highest weights,
wherein:
the map recorded in the memory contains at least one zone with favored direction of displacement associated:
with coordinates defining the position on the map of its periphery, and
with a favored direction of displacement in the zone,
the computer is programmed so as to, during step e) and for each particle:
detect the presence of the particle inside the zone with favored direction of displacement by comparing the coordinates of the particle with the periphery of the zone with favored direction of displacement defined by the coordinates provided during step a), and then,
if the particle is detected as being present inside the zone with favored direction of displacement, increase the weight of the particle if the angular deviation between the direction of displacement of the particle from the position Pₖ₋₁ⁱ to the position Pₖⁱ and the favored direction of displacement associated with the zone is equal to 0° or to 180° to within plus or minus σ_{γ}, the increasing being carried out with respect to the weights of the other particles situated inside the same zone and for which the deviation is not equal to 0° or to 180° to within plus or minus σ_{γ}, where σ_{γ} is a predetermined angular tolerance, and
if the particle is detected as being outside of the zone with favored direction of displacement, prohibit the use of the favored direction of displacement associated with the zone to update the weight of the particle.

11. A device directly transportable by a pedestrian who is moving in displacement inside a three-dimensional space, the device comprising an inertial platform able to measure physical quantities representative of the direction of displacement of the device and of the amplitude of the displacement,
wherein the device also comprises an electronic locating unit as claimed in claim 10.
